(19) United States
(12) Patent Application Publication
(10) Pub. No.: US 2006/0120550 A1
(43) Pub. Date: Jun. 8, 2006

(54) Integrated microphone stand and pedal board

(76) Inventor: Ted McCann, Los Angeles, CA (US)

Correspondence Address: Hovey Williams LLP, Suite 400, 2405 Grand Blvd., Kansas City, MO, 64108, US

(21) Appl. No.: 11/006,358

(22) Filed: Dec. 7, 2004

(51) Int. Cl. H04R 11/04; H04R 17/02; H04R 19/04

(52) U.S. Cl. 381/363; 381/366; 381/122

(57) ABSTRACT

An apparatus (10) for supporting a microphone (12) and a pedal switch (14) comprises a case (16) comprising first and second shells (18,20), a pedal support (22) secured within the first shell (18), and a reconfigurable microphone stand (24) that may alternatively be configured to extend from the pedal support (22) or be stored within the second shell (20). The pedal support (22) is mounted within the first shell (18) and includes a pedal board (58) substantially covered by a fastening material, such as a loop material (68) found in Velcro® fasteners. Likewise, a hook material (70) preferably covers a bottom surface (72) of the pedal switch (14). Thus, the pedal switch (14) may be gently pressed into the pedal board (58), thereby causing the hook material (70) to mate with the loop material (68) and hold the pedal switch (14) in position.

### BACKGROUND OF THE INVENTION

1. Field of the Invention

The present invention relates to stage equipment. More particularly, the present invention relates to an integrated apparatus for conveniently supporting a microphone and at least one pedal switch.

2. Description of the Related Art

Singers and other performers commonly use microphones to amplify their voices and pedal switches to control instruments during their performance. However, microphone stands commonly interfere with pedal switches. For example, microphone stands typically include a base located at a user's feet, exactly where pedal switches are most conveniently used. Thus, the base prevents the pedal switches from being placed where they could otherwise most conveniently be used.

Furthermore, pedal switches are typically placed on a stage or other smooth floor. During especially energetic performances, these pedal switches may be bumped or otherwise slid across the stage and away from a performer's microphone.

Accordingly, there is a need for an improved apparatus for conveniently supporting a microphone and at least one pedal switch that overcomes the limitations of the prior art.

### SUMMARY OF THE INVENTION

The present invention overcomes the above-identified problems and provides a distinct advance in the art of stage equipment. More particularly, the present invention provides an integrated apparatus for conveniently supporting a microphone and at least one pedal switch. The apparatus broadly comprises a case comprising first and second shells, a pedal support secured within the first shell, and a reconfigurable microphone stand that may alternatively be configured to extend from the pedal support or be stored within the second shell. The shells of the case are preferably selectively hinged by separable hinges located along a first side of each shell. Thus, the shells may be selectively rotatably secured to one another through approximately 180° of rotation. The case also preferably includes latches along a second side of each shell to secure the case in a closed configuration. The closed configuration is useful for transportation and storage of the apparatus, as the shells of the case house and protect the apparatus' other components.

The pedal support is preferably substantially permanently mounted within the first shell and includes a pedal board to support the pedal switch at an approximately fifteen degree angle. The pedal board is preferably substantially covered by a loop material, such as found in Velcro® fasteners. Likewise, a hook material preferably covers at least a portion of a bottom surface of the pedal switch. Thus, the pedal switch may be placed on the pedal board and gently pressed into the pedal board, thereby causing the hook material to mate with the loop material and hold the pedal switch in position. In this manner, the pedal switch may be positioned anywhere on the pedal board and remain so positioned until repositioned.

A first edge of the pedal board preferably extends beyond the first shell and a second edge of the pedal board preferably rests below a rim of the first shell. In this manner, the rim of the first shell may be used to retain pedal switches that do not have the hook material and would otherwise slide off the pedal board. Since the rim of the first shell is located below the first edge, the rim will not interfere with or damage any cables or other wiring extending from the pedal switch.

An internal space of the pedal support, between the pedal board and the first shell, may be used for additional storage. For example, the pedal support may or may not include a rear wall along the first edge of the pedal board. With no rear wall, items may simply slide between the rim of the first shell and the pedal board and be stored within the pedal support. Alternatively, the pedal board itself may be hinged along the second edge and therefore, may be rotated away from the walls to selectively allow access to the internal space.

A cuff preferably extends substantially vertically from the pedal board. The cuff comprises a cylindrical clamp to selectively and securely hold the microphone stand in a substantially vertical orientation. The cuff is preferably substantially centered along the first shell's width. In this manner, the pedal switch, or multiple pedal switches, may be placed to the left or right of the cuff. The cuff is also preferably located near the first edge of the pedal board, thereby allowing a pedal switch to be placed between the cuff and the rim of the first shell along the second edge of the pedal board.

The microphone stand is preferably divisible into a telescoping pole and a boom. The telescoping pole includes a lower end operable to be clamped within the cuff, thereby extending substantially vertically from the pedal board, and a threaded upper end. The boom preferably includes a microphone clip at a first end to hold the microphone, a handle at a second end, and a threaded bracket operable to mate with the upper end of the telescoping pole. The bracket preferably comprises a sleeve slidable between the first end and the second end of the boom and an interiorly threaded cylinder extending from the sleeve. The sleeve preferably includes a thumb screw to fix the bracket's position along the boom. The cylinder preferably rotatably attaches to the sleeve so as to adjust an angle between the sleeve and the cylinder. Another thumb screw may be used to fix the angle between the sleeve and the cylinder and therefore, the angle between the telescoping pole and boom.

The second shell of the case preferably includes a pair of mounting blocks secured therein. A first block preferably defines two holes to accept the lower end of the telescoping pole and the second end of the boom. The first block is preferably secured within a corner of the second shell with the holes oriented along the second shell's width. A second block preferably includes two slots to accept the telescoping pole and boom and a strap to selectively retain the pole and boom within the slots. The slots are preferably vertically aligned, such that the pole and boom may be lowered into the slots. The strap is preferably constructed of loop material and is selectively secured to hook material permanently secured to the second block.

### BRIEF DESCRIPTION OF THE DRAWINGS

A preferred embodiment of the present invention is described in detail below with reference to the attached drawing figures, wherein:

FIG. 1 is an isometric view of an integrated microphone stand and pedal board constructed in accordance with a preferred embodiment of the present invention and particularly illustrating a case for carrying the microphone stand and pedal board;

FIG. 2 is an isometric view of the microphone stand and pedal board of FIG. 1, particularly illustrating the microphone stand extending from the pedal board;

FIG. 3 is a fragmentary isometric view of a rear of the case, particularly illustrating a hinge on the case; and

FIG. 4 is a fragmentary isometric view of a front of the case, particularly illustrating a latch on the case.

### DETAILED DESCRIPTION OF A PREFERRED EMBODIMENT

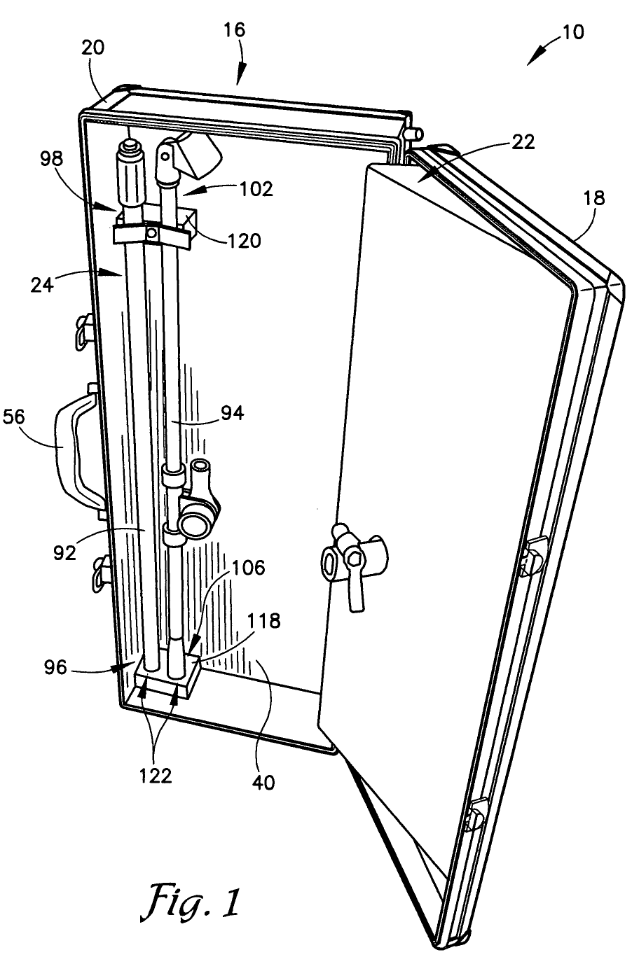

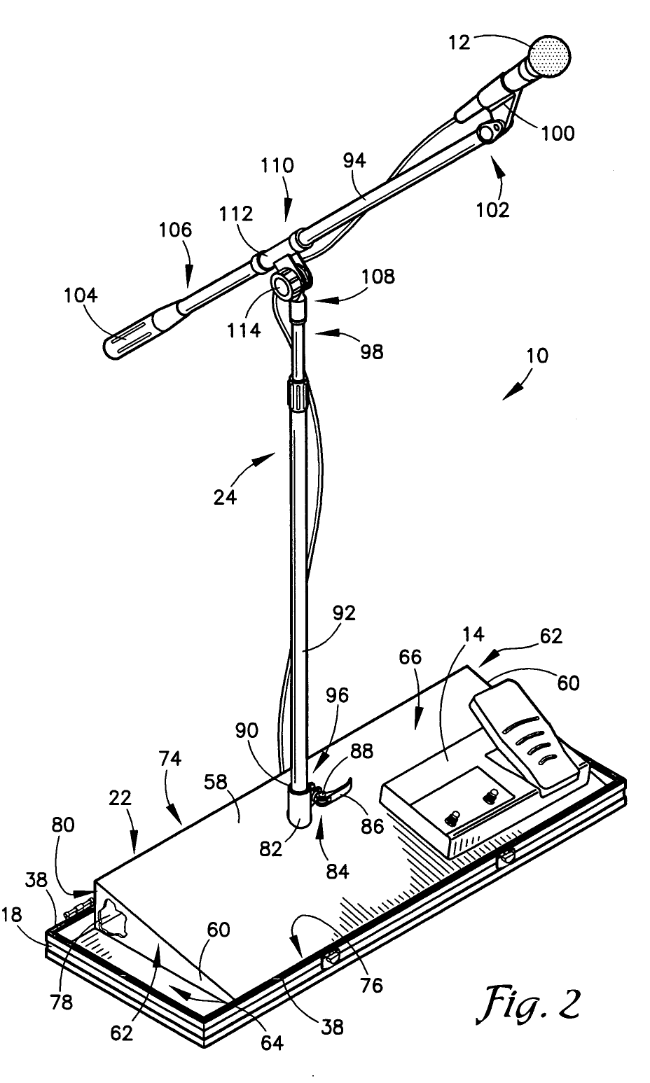

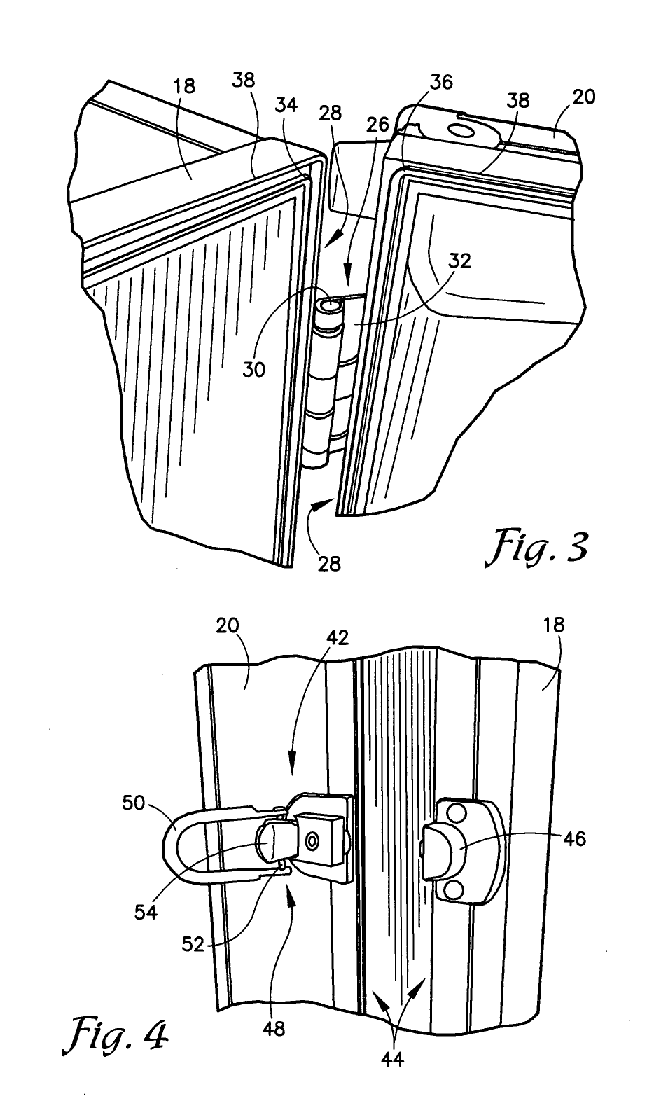

Referring to FIGS. 1 and 2, the preferred apparatus 10 constructed in accordance with a preferred embodiment of the present invention is illustrated supporting a microphone 12 and a pedal switch 14. The apparatus 10 broadly comprises a case 16 comrpising first and second shells 18,20, a pedal support 22 secured within the first shell 18, and a reconfigurable microphone stand 24 that may alternatively be configured to extend from the pedal support 22 or may be stored within the second shell 20. As illustrated in FIG. 3, the shells 18,20 of the case 16 are preferably selectively hinged by three separable hinges 26 located along a first side 28 of each shell 18,20. The hinges 26 each include a hinge pin 30 offset from the first shell 18 and an arcuate flange 32 extending from the second shell 20. With the hinge pins 30 positioned within the flanges 32, the first shell 18 is rotated about the hinge pins 30 and mated with the second shell 20. To facilitate such mating, the first shell 18 preferably includes a perimeter ridge 34 which fits within a perimeter channel 36 of the second shell 20. The ridge 34 and channel 36 extend around a rim 38 of each shell 18,20, respectively.

Thus, the shells 18,20 may be selectively rotatably secured to one another through approximately 180° of rotation. This configuration is useful for transportation and storage of the apparatus 10, as the shells 18,20 of the case 16 house and protect the apparatus' 10 other components. For this reason, the case 16 is preferably primarily constructed of metal, such as aluminum or steel, or another suitable durable and rigid material. To further protect its contents, the case 16 may also be lined with a resilient material 40, such as rubber, or another suitable impact and scratch resistant material. In a closed configuration, the case 16 is preferably approximately six inches tall, approximately twelve and one half inches deep, and approximately thirty-three inches wide.

As illustrated in FIG. 4, the case 16 also preferably includes two latches 42 along a second side 44 of each shell 18,20 to secure the case 16 in the closed configuration. In the preferred embodiment, the latches 42 each include a shoulder 46 mounted to the first shell 18 and a ring assembly 48 mounted to the second shell 20. The ring assembly 48 includes an elongated u-shaped ring 50 having a pin 52 that extends through a cam mechanism 54. With the cam mechanism 54 in an unlatched position, the ring 50 may be easily positioned upon the shoulder 46. Then, the cam mechanism 54 is repositioned to a latched position, thereby moving the pin 52 away from the first shell 18 and firmly seating the ring 50 upon the shoulder 46. In this manner, the latches 42 selectively secure the shells 18,20 together and any contents of the case 16 within the case 16.

In order to separate the shells 18,20, the latches 42 are first unsecured by moving the cam mechanism 54 to the unlatched position and removing the ring 50 from the shoulder 46. The first shell 18 is then rotated 180° or more, with respect to the second shell 20, and the hinge pins 30 are removed from the flanges 32. With the shells 18,20 separated, the apparatus 10 may be configured for use. Specifically, the first shell 18 is preferably positioned on an exterior surface thereof, with the rim 38 oriented upwardly, thereby resting on a stage or other floor where a performer will sit or stand while using the apparatus 10, as illustrated in FIG. 2. The microphone stand 24 may then be affixed to the pedal support 22, as will be explained in further detail below, and extended upwardly from the first shell 18. In this configuration, the apparatus 10 is ready for use and the microphone 12 and pedal switch 14 may be positioned as desired.

The second shell 20 may be temporarily discarded, as its primary function is to complete the case 16, thereby housing and protecting the apparatus' 10 other components during transportation and storage. Thus, the second shell 20 may include one or more handles 56 to aid in transportation of the apparatus 10 and any other components not required during use of the apparatus 10.

The pedal support 22 is preferably substantially permanently mounted within the first shell 18 and includes a pedal board 58 to support the pedal switch 14 and at least two vertical walls 60 to support the pedal board 58. The pedal board 58 is preferably aligned at an approximately fifteen degree angle with respect to the stage or floor, with the first shell 18 positioned for use as described above. Thus, the walls 60 are preferably wedge shaped, in order to support the pedal board 58 at the angle, and are preferably located at opposing side edges 62 of the pedal board 58. In some applications, a third, and even a fourth, vertical wall may be located nearer the center of the pedal board 58 in order to provide additional support for the pedal board 58.

The pedal board 58 and the walls 60 are preferably constructed from a suitably rigid material, such as wood, metal, plastic, fiberglass, or other composites. The pedal board 58 is preferably approximately eleven and three quarter inches deep and approximately twenty-nine and one half inches wide. Thus, it can be seen that the pedal board 58 is preferably narrower than the first shell 18 of the case 16, thereby providing a recess 64 along one or both side edges 62 of the pedal board 58 into which objects, such as a power strip (not shown), may be placed and/or stored.

At least an upper surface 66 of the pedal board 58 is preferably substantially covered by a fastening material, such as a loop material found in Velcro® fasteners. Likewise, a hook material (not shown) preferably covers at least a portion of a bottom surface of the pedal switch 14. Thus, the pedal switch 14 may be placed on the pedal board 58 and gently pressed into the pedal board 58, thereby causing the hook material to mate with the loop material and hold the pedal switch 14 in position. In this manner, the pedal switch 14 may be positioned anywhere on the pedal board 58 and remain so positioned until repositioned.

A first edge 74 of the pedal board 58 preferably extends above the first shell 18 and a second edge 76 of the pedal board 58 preferably rests below the rim 38 of the first shell 18. In this manner, the rim 38 of the first shell 18 may be used to retain pedal switches 14 that do not have hook material (not shown) and would otherwise slide off the pedal board 58. As the first edge 74 of the pedal board 58 extends above the first shell 18 of the case 16, pedal switches having downwardly extending flanges may be hung from the first edge 74, thereby preventing such pedal switches from sliding off the pedal board 58. Additionally, since the rim 38 of the first shell 18 is located below the first edge 74, the rim 38 will not interfere with or damage any cables or other wiring extending from the pedal switch 14.

An internal space 78 of the pedal support 22, between the pedal board 58 and the first shell 18, may be used for additional storage. For example, the pedal support 22 may or may not include a rear wall 80 along the first edge 74 of the pedal board 58. With no rear wall 80, items may simply slide between the rim 38 of the first shell 18 and the pedal board 58 and be stored within the pedal support 22. Alternatively, the pedal board 58 itself may be hinged along the second edge 76 and therefore, may be rotated away from the walls 60,80 to selectively allow access to the internal space 78. Finally, any of the walls 60,80 may be removable, thereby allowing access to the internal space 78.

A cuff 82 preferably extends substantially vertically above the pedal board 58. The cuff 82 may be secured directly to the pedal board 58 and rotate with the pedal board 58 if hinged as described above. Alternatively, the cuff 82 may be counter sunk into the pedal support 22 and secured directly to the first shell 18 and/or any of the walls 60,80. The cuff 82 is preferably substantially centered along the first shell's 18 width. In this manner, the pedal switch 14, or multiple pedal switches, may be placed to the left or right of the cuff 82. The cuff 82 is also preferably located near the first edge 74 of the pedal board 58, thereby allowing a pedal switch 14 to be placed between the cuff 82 and the rim 38 of the first shell 18 along the second edge 76 of the pedal board 58.

The cuff 82 preferably comprises a cylindrical quick-release clamp 84 to selectively and securely hold the microphone stand 24 in a substantially vertical orientation. The clamp 84 is preferably operated by a lever 86 of a cam mechanism 88 that selectively reduces an internal diameter of the cuff 82, thereby clamping the microphone stand 24. The cam mechanism 88 is preferably adjustable to accommodate a variety of microphone stands. The cuff 82 may also include a cylindrical resilient grommet 90 fitting into the clamp 84 and around the microphone stand 24, thereby protecting the microphone stand 24 from the clamp 84 while ensuring the clamp 84 obtains a sufficient grip on the microphone stand 24.

The microphone stand 24 is preferably divisible into a telescoping pole 92 and a boom 94. The pole 92 preferably includes a lower end 96 operable to be clamped within the cuff 82, thereby extending substantially vertically from the pedal board 58, and a threaded upper end 98. The boom 94 preferably includes a microphone clip 100 at a first end 102 to hold the microphone 12, a handle 104 at a second end 106 opposing the first end 102, and a threaded bracket 108 operable to mate with the upper end 98 of the telescoping pole 92. The pole and boom 92,94 are preferably approximately thirty-one inches long and primarily constructed of a rigid tubular material, such as steel or aluminum. However, the clip 100, the handle 104, and the bracket 108 may also be constructed of plastic or another composite to reduce weight and manufacturing costs, as well as improve resistance to corrosion. Furthermore, the threaded portions of the microphone stand 24 may be constructed of brass in order to prevent corrosion.

The bracket 108 preferably comprises a sleeve 110 slidable between the first end 102 and the second end 106 of the boom 94 and an interiorly threaded cylinder 112 extending from the sleeve 110. The sleeve 110 preferably includes a thumb screw 114 to fix the bracket's 108 position along the boom 94. The cylinder 112 preferably rotatably attaches to the sleeve 110, in order to adjust an angle between the sleeve 110 and the cylinder 112. Another thumb screw (not shown) may be used to fix the angle between the sleeve 110 and the cylinder 112, and therefore the angle between the pole 92 and the boom 94.

The second shell 20 of the case 16 preferably includes a pair of mounting blocks 118,120 secured therein. A first one of the blocks 118 preferably defines two holes 122 to accept the lower end 96 of the pole 92 and the second end 106 of the boom 94. The first block 118 is preferably secured within a corner of the second shell 20 with the holes 122 oriented along the second shell's 20 width. A second one of the blocks 120 preferably includes a selectively rotatable latch that may be rotated over the upper end 98 of the pole 92 and the second end 106 of the boom 94 to secure the pole 92 and boom 94 in place. Alternatively, a second one of the blocks 120 may define two slots (not shown) operable to accept the pole 92 and boom 94 and a strap (not shown) to selectively retain the pole 92 and boom 94 within the slots. The slots are preferably vertically aligned, such that the pole 92 and boom 94 may be lowered therein. The strap is preferably constructed of the loop material and is selectively secured to hook material permanently secured to the second block 120.

While the present invention has been described above, it is understood that substitutions may be made. For example, the pedal board 58 may be aligned at between ten and twenty degrees with respect to the stage. The second shell 20 may include additional structure to selectively hold the microphone 12 and/or the pedal switch 14 during transportation and storage. Furthermore, selected functionality of the shells 18,20 may be reversed. For example, the hinge pins 30 may extend from the second shell 20 rather than the first shell 18 as described above. Finally, the pedal switch 14 may be built into the pedal support 22. For example, the pedal switch's 14 internal components may be located within the internal space 78 with only a portion of the pedal switch 14 extending above the pedal board 58.

While the dimensions described above are of the preferred embodiment, slight variations are possible without departing from the scope of the present invention. For example, the case 16 may be between approximately three inches and approximately twelve inches tall, between approximately six inches and approximately twenty inches deep, and between approximately twelve and approximately forty-eight inches wide when in the closed configuration. Thus, the pedal support 22 may be between approximately twenty inches and approximately forty inches wide. The first shell 16 may be between approximately one inch and approximately six inches tall. These and other minor modifications are within the scope of the present invention.

In use, the apparatus 10 is transported to the stage. The latches 42 are unsecured and the shells 18,20 are separated, as described above. The first shell 18 is placed, rim 38 up, where the performer wishes to support the pedal switch 14. The microphone stand 24 is removed from the second shell 20 and assembled by threading the upper end 98 of the pole 92 into the cylinder 12 of the boom 94. The microphone stand 24 is then mated to the cuff 82 by sliding the lower end 96 into the clamp 84 and operating the lever 86. The apparatus 10 is now ready to accept the microphone 12 and the pedal switch 14 as desired and described above.

The boom 94 may be articulated as desired, in order to position the microphone 12 relative to the pedal switch 14. For example, if the performer plans to stand while using the apparatus 10, the boom 94 would likely be oriented to extend substantially vertically from the pole 92. Specifically, the sleeve 110 would preferably be positioned near the handle 104 of the boom 94 with the cylinder 112 substantially parallel to the boom 94. Alternatively, especially where the performer plans to sit while using the apparatus 10, the boom 94 would likely be oriented to extend transversely from the pole 92. Specifically, the cylinder 112 would extend generally perpendicularly to the pole 92. Of course, variations of the angle between the pole 92 and boom 94, as well as the sleeve's 110 position along the boom 94, are expected to vary greatly with the performer's height and preferences.

Having thus described a preferred embodiment of the invention, what is claimed as new and desired to be protected by Letters Patent includes the following:

1. An apparatus supporting a microphone and at least one pedal switch, the apparatus comprising:
a pedal board operable to support the pedal switch and having a fastening material for holding the pedal switch in place;
a microphone stand extending above the pedal board and operable to support the microphone; and
a case into which the pedal board and microphone stand pole may be secured.

2. The apparatus as set forth in claim 1, wherein the case is approximately six inches tall, approximately twelve and one half inches deep, and approximately thirty-three inches wide when closed.

3. The apparatus as set forth in claim 1, wherein the case is further operable to be divided into a first shell and a second shell, the shells being selectively hinged by a plurality of separable hinges located along a first side of each shell and being selectively secured together by at least one latch along a second side of each shell;

4. The apparatus as set forth in claim 3, wherein the pedal board is permanently mounted within the first shell of the case, such that a first edge of the pedal board extends beyond the first shell and a second edge of the pedal board rests below a rim of the first shell.

5. The apparatus as set forth in claim 3, wherein the microphone stand includes a telescoping pole separable from a boom with both the pole and boom being selectively secured within the second shell of the case.

6. The apparatus as set forth in claim 1, wherein the case is between approximately three inches and approximately one foot tall, between approximately six inches and approximately twenty inches deep, and between approximately twenty-four inches and approximately forty-eight inches wide when closed.

7. The apparatus as set forth in claim 1, wherein the pedal board is between approximately twenty inches and approximately forty inches wide.

8. The apparatus as set forth in claim 1, wherein the pedal board is approximately eleven and three quarter inches deep and approximately twenty-nine and one half inches wide.

9. The apparatus as set forth in claim 1, wherein the pedal board is narrower than the case, thereby providing a recess along a side of the pedal board for storage.

10. The apparatus as set forth in claim 1, further including an interior space below the pedal board for storage.

11. The apparatus as set forth in claim 10, wherein the interior space is accessible by rotating the pedal board.

12. An apparatus supporting a microphone and at least one pedal switch, the apparatus comprising:
a case comprising first and second shells selectively hinged by a plurality of separable hinges located along a first side of each shell and being selectively secured together by at least one latch along a second side of each shell;
a pedal board substantially permanently secured within the first shell and operable to support the pedal switch and having a loop material for holding the pedal switch in place; and
a microphone stand extending above the pedal board and operable to support the microphone.

13. The apparatus as set forth in claim 12, wherein the pedal board is permanently mounted within the first shell of the case, such that a first edge of the pedal board extends beyond the first shell and a second edge of the pedal board rests below a rim of the first shell.

14. The apparatus as set forth in claim 12, wherein the microphone stand includes a telescoping pole separable from a boom with both the pole and boom being selectively secured within the second shell of the case.

15. The apparatus as set forth in claim 12, wherein the case is between approximately three inches and approximately one foot tall, between approximately six inches and approximately twenty inches deep, and between approximately twenty-four inches and approximately forty-eight inches wide when closed.

16. The apparatus as set forth in claim 12, wherein the pedal board is between approximately twenty inches and approximately forty inches wide.

17. The apparatus as set forth in claim 12, wherein the pedal board is narrower than the case, thereby providing a recess along a side of the pedal board for storage.

18. The apparatus as set forth in claim 12, further including an enclosed interior space below the pedal board for storage.

19. The apparatus as set forth in claim 18, wherein the interior space is accessible by rotating the pedal board.

20. An apparatus supporting a microphone and at least one pedal switch, the apparatus comprising:
a case comprising first and second shells selectively hinged by a plurality of separable hinges located along a first side of each shell and being selectively secured together by at least one latch along a second side of each shell, wherein the case is approximately six inches tall, approximately twelve and one half inches deep, and approximately thirty-three inches wide when closed;
a pedal support substantially permanently secured to the first shell and having a pedal board to support the pedal switch and at least two vertical walls to support the pedal board at an angle between approximately ten degrees and approximately twenty degrees, wherein the pedal board is substantially covered by a loop material, a first edge of the pedal board extends beyond the first shell, and a second edge of the pedal board terminates within the first shell;
a cuff extending substantially vertically from the pedal support;
a telescoping pole having a lower end operable to be clamped within the cuff, thereby extending substantially vertically above the pedal board, and a threaded upper end opposing the lower end;
a boom having a microphone clip at a first end to hold the microphone, a handle at a second end, opposing the first end, and a threaded bracket operable to mate with the upper end and slidable between the first and second ends; and
a pair of mounting blocks substantially permanently secured within the second shell, a first one of the blocks defining a plurality of holes operable to accept both the lower end of the telescoping pole and the second end of the boom, a second one of the blocks defining a plurality of slots operable to accept the pole and boom, and a strap operable to selectively retain the pole and boom within the slots.
